(19) United States
(12) Patent Application Publication
(10) Pub. No.: US 2013/0120933 A1
(43) Pub. Date: May 16, 2013

(54) MOBILE COMPUTER DEVICE

(71) Applicant: Shao-Chieh TING, New Taipei City (TW)

(72) Inventor: Shao-Chieh TING, New Taipei City (TW)

(21) Appl. No.: 13/297,820

(22) Filed: Nov. 16, 2011

(51) Int. Cl. G06F 1/16

(52) U.S. Cl. 361/679.55

(57) ABSTRACT

The present invention discloses a mobile computer device, including a tablet personal computer or a laptop computer. In terms of the visual sense when using the computer, the present invention not only meets the requirement of ergonomics but enhances the heat dissipation effect of the computer. In particular, a tablet personal computer can be put upright on a desktop to facilitate reading by a consumer. The structures of the present invention are simple and easy to be implemented; the implementation can be accomplished in five seconds by fingers of both hands. Therefore, the present invention is indeed a novel creation that breaks through the conventional technology and is practical.

### BACKGROUND OF THE INVENTION

a) Field of the Invention

The present invention relates to a mobile computer device, and more particularly to a mobile computer device wherein through providing brackets at the bottom of the mobile computer device, the screen of a laptop computer can be raised to facilitate operation by a user. In addition, the heat dissipation effect of the computer can be enhanced and a tablet personal computer can be put uprightly or obliquely to facilitate operating the keyboard on the screen, viewing a video clip or reading by the user.

b) Description of the Prior Art

As development of technologies, one must pursue a mobile computer of small size and light weight so that the user can carry it conveniently. However, when the laptop computer is getting smaller, the user convenience in operation will be limited in someway.

Accordingly, a lot of bases or brackets for assisting the mobile computers arise in markets to improve the limitation of use. Nevertheless, these bases or brackets should be purchased additionally, which increases the cost and the space for carrying.

In the mobile computer device provided by the present invention, the brackets and the mobile computer are combined, so that the requirement of use can be satisfied without the need for purchasing other devices.

### SUMMARY OF THE INVENTION

The primary object of the present invention is to provide a mobile computer device with a bracket function. The mobile computer device includes a mobile computer unit and plural brackets that can be pulled out and collected easily.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1A shows a three-dimensional schematic view of a first embodiment of the present invention wherein brackets are collected.

FIG. 1B shows a three-dimensional schematic view of the first embodiment of the present invention wherein the brackets are rotated open.

FIG. 2 shows a three-dimensional exploded view of the brackets of the first embodiment of the present invention.

FIG. 3A shows a front view of the first embodiment of the present invention wherein the brackets are rotated open.

FIG. 3B shows a rear view of the first embodiment of the present invention wherein the brackets are rotated open.

FIG. 4 shows a side view of the first embodiment of the present invention wherein the brackets are rotated open.

FIG. 5 shows a bottom view of the first embodiment of the present invention.

FIG. 6A shows a three-dimensional schematic view of a second embodiment of the present invention wherein the brackets are collected.

FIG. 6B shows a three-dimensional schematic view of the second embodiment of the present invention wherein the brackets are rotated open.

FIG. 7A shows a three-dimensional front view of a state of use of the second embodiment of the present invention when the brackets are rotated open.

FIG. 7B shows a three-dimensional rear view of the state of use of the second embodiment of the present invention when the brackets are rotated open.

FIG. 8A shows a three-dimensional front view of a state of use of the second embodiment of the present invention when the brackets are rotated open.

FIG. 8B shows a three-dimensional rear view of a second state of use of the second embodiment of the present invention when the brackets are rotated open.

FIG. 9A shows a side view of a state of use that a tablet personal computer is put obliquely when the brackets are rotated open, according to the second embodiment of the present invention.

FIG. 9B shows a side view of a state of use that a tablet personal computer is put uprightly when the brackets are rotated open, according to the second embodiment of the present invention.

FIG. 10A shows a bottom view of the second embodiment of the present invention.

FIG. 10B shows a bottom view of a third embodiment of the present invention.

### DETAILED DESCRIPTION OF THE PREFERRED EMBODIMENTS

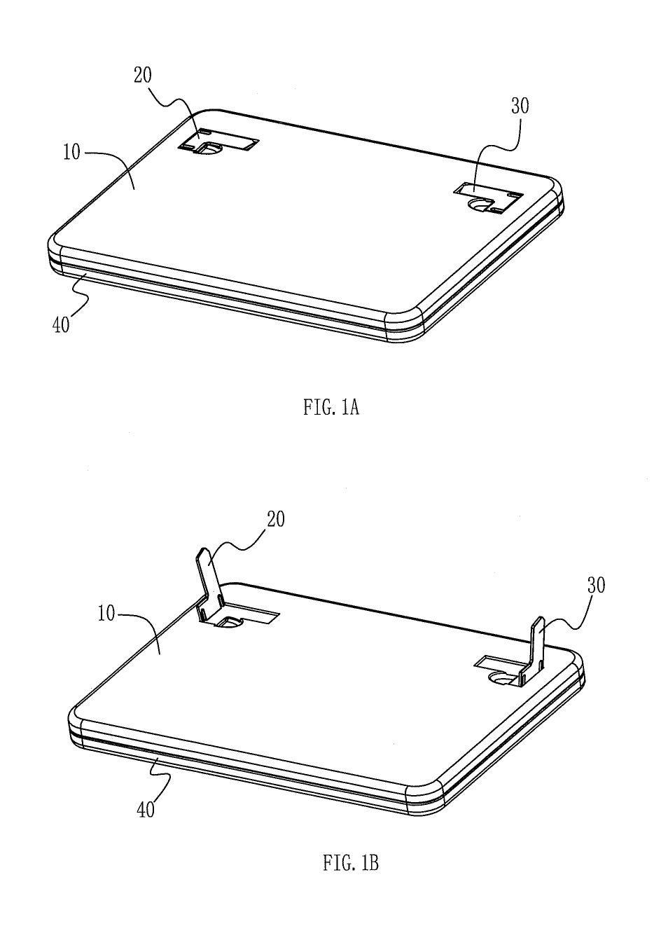

Referring to FIG. 1A and FIG. 1B, it shows three-dimensional schematic views of a first embodiment of the present invention, applying to a laptop computer with brackets being collected and rotated open, respectively. As shown in the drawings, the laptop computer device comprises a laptop computer base 10, a right bracket 20, a left bracket 30 and a view screen 40.

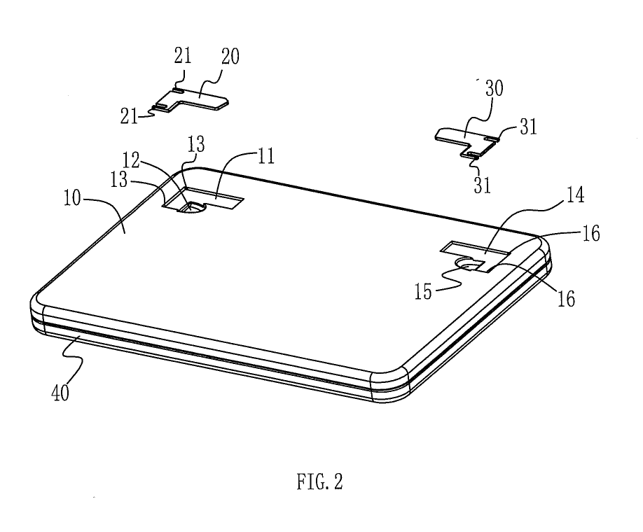

Referring to FIG. 2 at a same time, it shows a three-dimensional exploded view of the brackets of the first embodiment of the present invention. A bottom of the laptop computer base 10 is provided with a right bracket holding slot 11 and a left bracket holding slot 14, finger slots 12, 15 for rotating open the brackets, as well as shaft holes 13, 16 for sheathing with pivots of the brackets.

The right bracket 20 and the left bracket 30 are provided respectively in the right bracket holding slot 11 and the left bracket holding slot 14 at the bottom of the laptop computer base 10 to raise a laptop computer. An end of the left or right bracket is provided with a pivot 21 (31) to be sheathed with the shaft hole provided on the base 10, thereby achieving an object of rotating open and closed.

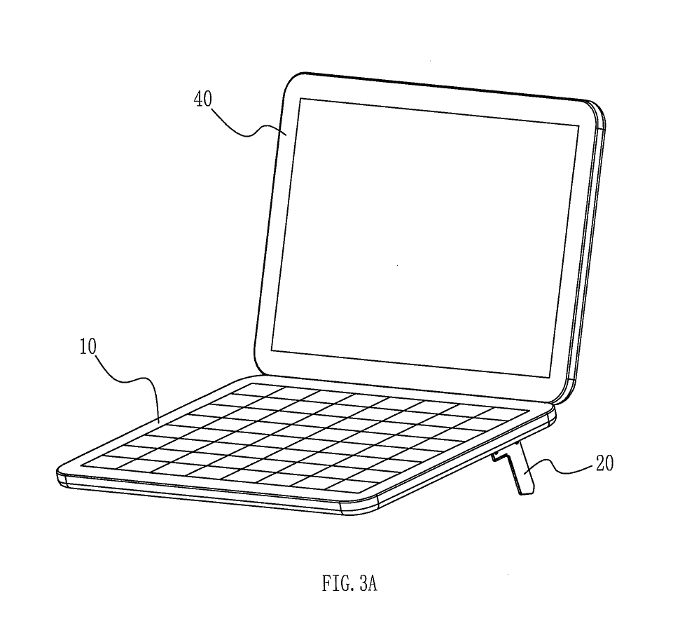

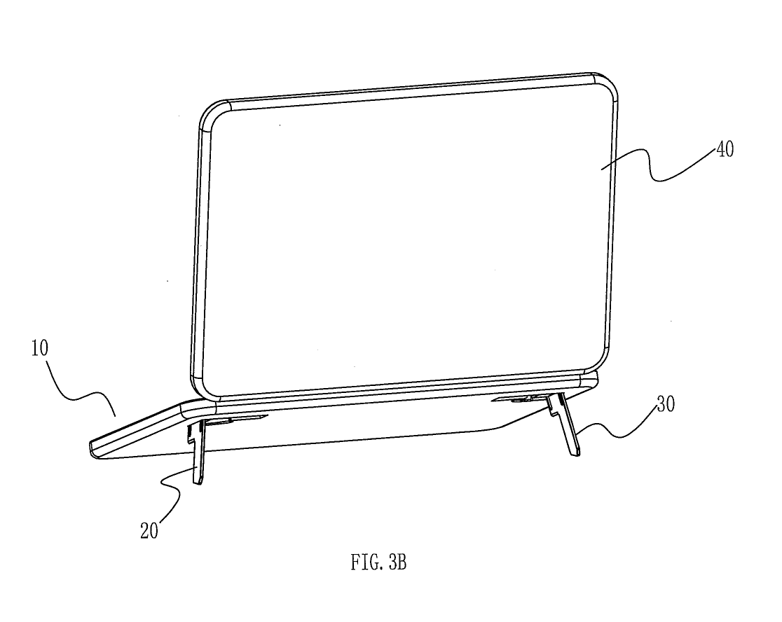

Referring to FIG. 3A and FIG. 3B, it shows respectively a front view and a rear view of the first embodiment of the present invention wherein the left and right bracket 20, 30 are rotated open. The view screen 40 is raised to satisfy ergonomics and facilitate dissipating heat of the laptop computer.

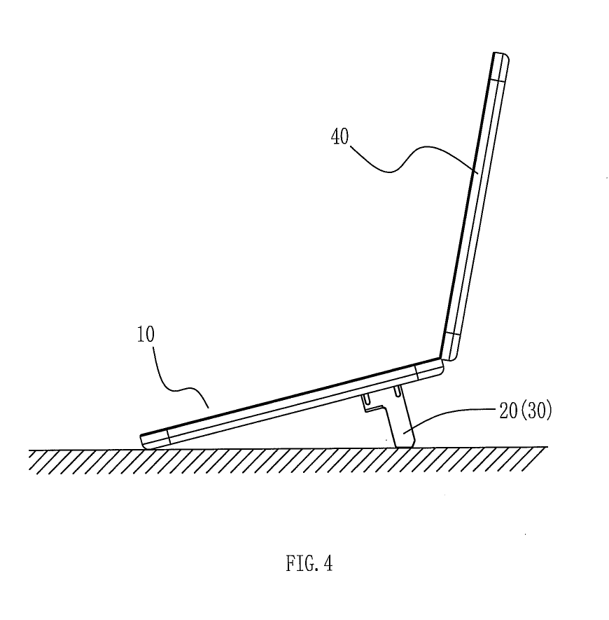

Referring to FIG. 4, it shows a side view of the first embodiment of the present invention wherein the left and right bracket 20, 30 are rotated open for use.

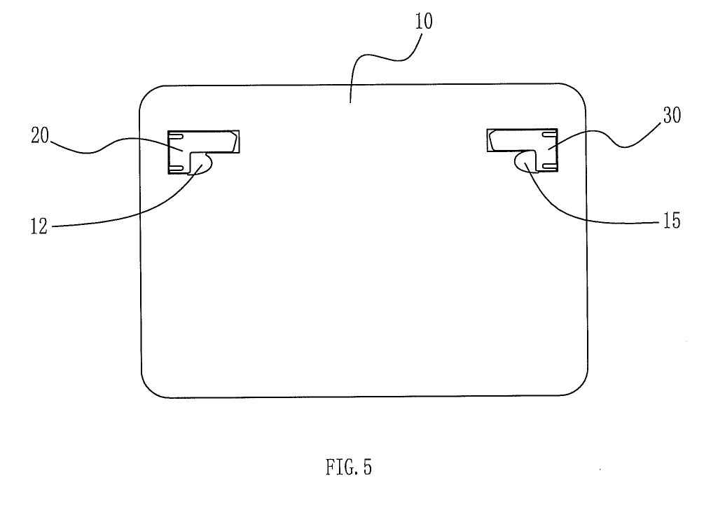

Referring to FIG. 5, it shows a bottom view of the first embodiment of the present invention, applying to a laptop computer. The drawing discloses the positions of the brackets 20, 30 on the base 10 and the provision of the finger slots 12, 15 for rotating out the brackets 20, 30.

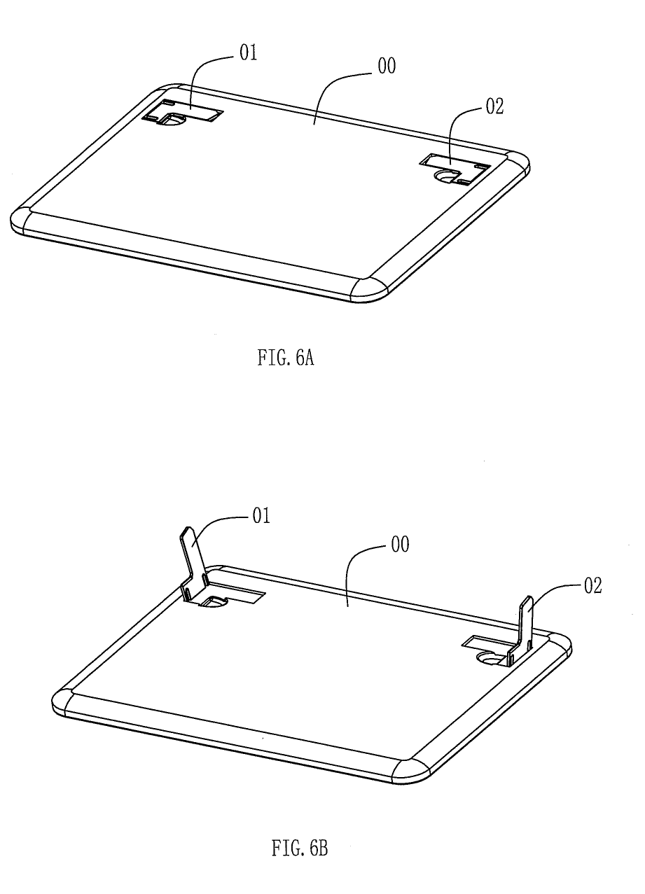

Referring to FIG. 6A and FIG. 6B, it shows three-dimensional schematic views of a second embodiment of the present invention, applying to a tablet personal computer 00 with bottom brackets being collected and rotated open, respectively. The bottom of the tablet personal computer 00 can be also provided with two brackets 01, 02 to put the tablet personal computer 00 obliquely or uprightly.

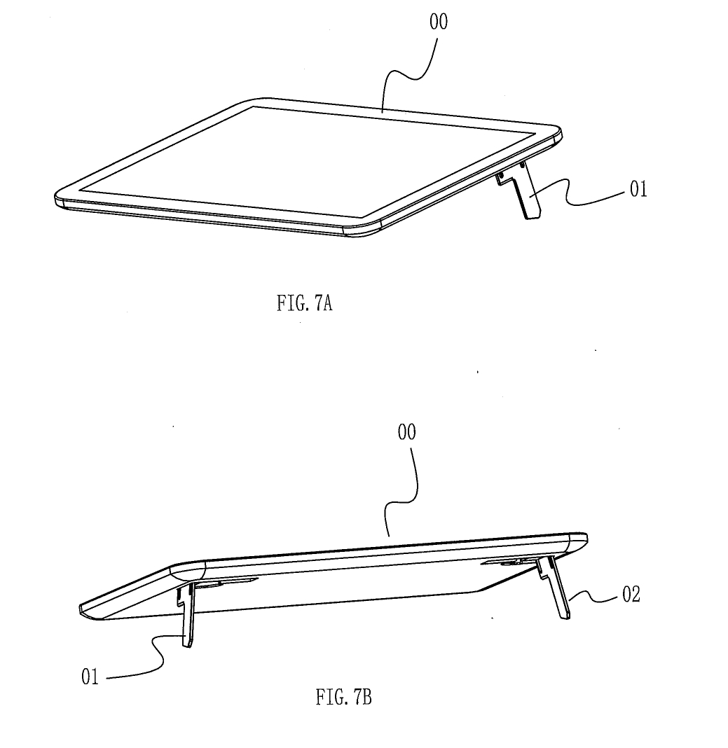

Referring to FIG. 7A and FIG. 7B, it shows three-dimensional schematic views of the second embodiment of the present invention, with the left and right bracket 01, 02 being rotated open on the tablet personal computer 00 and the tablet personal computer 00 being put obliquely by different angles, respectively. This configuration allows a user to operate the screen keyboard easily.

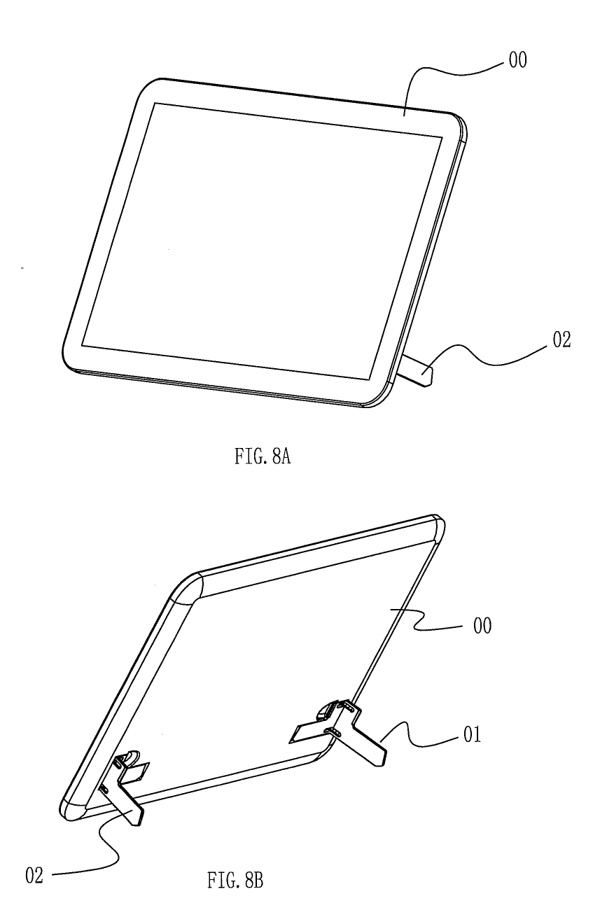

Referring to FIG. 8A and FIG. 8B, it shows three-dimensional schematic views of the second embodiment of the present invention, with the left and right bracket 01, 02 being rotated open on the tablet personal computer 00 and the tablet personal computer 00 being put uprightly by different angles, respectively. This configuration allows the user to watch a video clip and read easily.

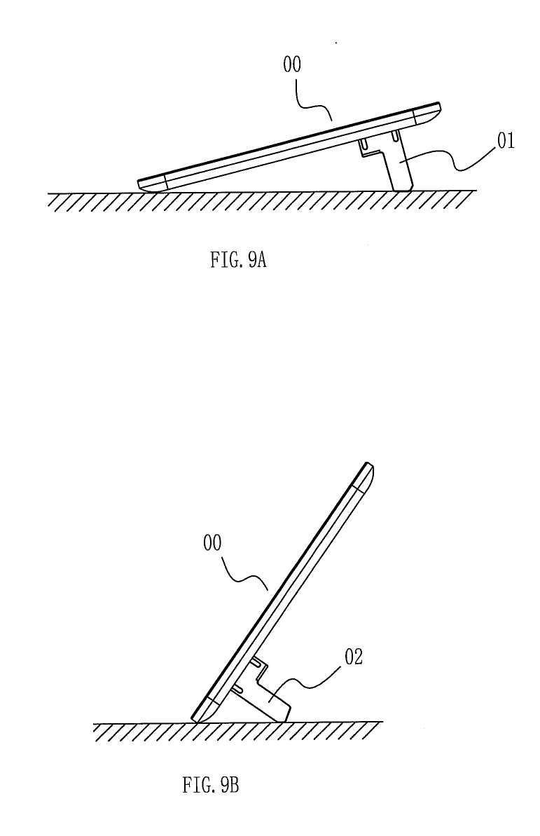

Referring to FIG. 9A and FIG. 9B, it shows side views of the second embodiment of the present invention, with the left and right bracket 01, 02 being rotated open on the tablet personal computer 00 and the tablet personal computer 00 being put obliquely and uprightly, respectively.

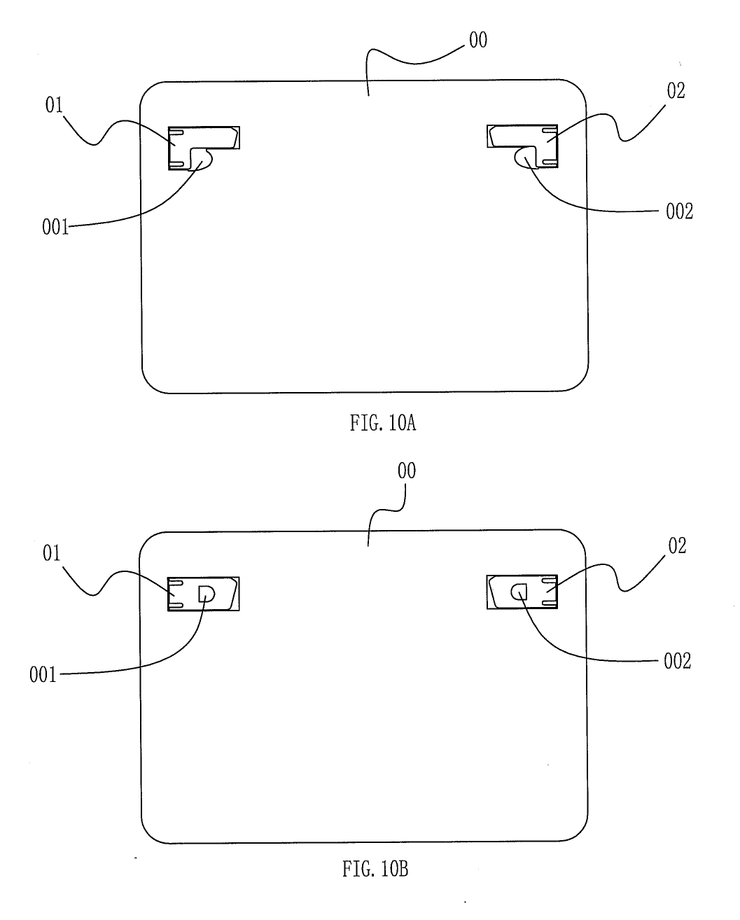

Referring to FIG. 10A, it shows a bottom view of the second embodiment of the present invention, applying to the tablet personal computer 00. The drawing discloses the positions of the brackets 01, 02 on the base and the provision of the finger slots 001, 002 for rotating out the brackets 01, 02.

Referring to FIG. 10B, it shows a bottom view of a third embodiment of the present invention, applying to the tablet personal computer 00. The drawing discloses the positions of the finger slots 001, 002 on the left and right brackets 01, 02, so that the bottom space of the mobile computer or the tablet personal computer can be utilized properly.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A mobile computer device comprising:
a mobile computer, a rear side at a bottom of the mobile computer is provided with bracket holding slots to emplace brackets and finger slots to rotate open the brackets; and
plural brackets, an end of each bracket is provided with a pivot sheathing with a shaft hole on a base so that the bracket rotates, the brackets being rotated open and collected to raise a screen of the mobile computer, thereby facilitating a user to operate the computer.

2. The mobile computer device according to claim 1, wherein a finger slot is located on each bracket.
